(19) United States
(12) Patent Application Publication
(10) Pub. No.: US 2012/0259683 A1
(43) Pub. Date: Oct. 11, 2012

(54) METHODS AND APPARATUS TO GENERATE AND UTILIZE VENUE PROFILES

(76) Inventors: Laura Cochran, San Diego, CA (US); Mark Orlando Nelson, Rancho Santa Fe, CA (US)

(21) Appl. No.: 13/178,857

(22) Filed: Jul. 8, 2011

Related U.S. Application Data
(60) Provisional application No. 61/474,234, filed on Apr. 11, 2011.

(51) Int. Cl. G06Q 30/00

(52) U.S. Cl. 705/14.4

(57) ABSTRACT

Methods and apparatus to generate and utilize venue profiles are disclosed. An example method includes selecting an attribute for a non-residential-based venue indicative of a type of person likely to attend the non-residential-based venue; obtaining at least one of demographic data or psychographic data associated with the attribute; and generating, using a processor, a venue profile for the non-residential-based venue using the at least one of the demographic data or psychographic data associated with the attribute.

### RELATED APPLICATIONS

This patent claims the benefit of U.S. Provisional Application No. 61/474,234, filed Apr. 11, 2011, which is hereby incorporated herein in its entirety.

### FIELD OF THE DISCLOSURE

This disclosure relates generally to advertising, and, more particularly, to methods and apparatus to generate and utilize venue profiles.

### BACKGROUND

Advertisements are often placed across different types of media and/or advertisement spaces to extend the reach of a campaign. For example, an advertisement campaign for a particular product may include placement of a first advertisement in commercial breaks of selected television broadcasts. Additionally or alternatively, the advertisement campaign may include placement of a second advertisement at one or more out-of-home advertisement spaces, such as digital billboards located along roadways, static billboards located along roadways, digital or static outdoor signage located on buildings or bus stop shelters, signage posted at public places, such as airports, shopping centers, hotel lobbies, theme parks, sporting arenas, amusement parks, convenient stores, etc.

### BRIEF DESCRIPTION OF THE DRAWINGS

FIG. 1 is an illustration of a plurality out-of-home advertisement spaces located at a plurality of venues.

FIG. 2 is an illustration of a plurality of entities involved in placement of advertisements at the out-of-home advertisement spaces of FIG. 1.

FIG. 3 is a block diagram of an example apparatus that may be used to implement the example venue profiler of FIG. 2.

FIG. 4 is a flowchart representative of example machine readable instructions that may be executed to implement the example venue profiler of FIGS. 2 and/or 3.

FIG. 5 is a flowchart representative of example machine readable instructions that may be executed to implement the example venue profiler of FIGS. 2 and/or 3.

FIG. 6 is an example processor platform capable of executing the example machine readable instructions of FIGS. 4 and/or 5 to implement the example venue profiler of FIGS. 2 and/or 3.

### DETAILED DESCRIPTION

Entities that advertise products and/or services, such as manufacturers, retailers, service providers, etc., and other entities involved in the advertising industry, such as media planners, creative agencies, market researchers, etc. are often interested in data associated with exposure of people or demographic groups of people to advertisements. Techniques for collecting exposure information and/or the types of exposure information to be collected sometimes vary according to the media on which the advertisements of interest are placed. For example, to measure exposure to advertisements placed in television broadcasts, groups of demographically segmented panelists agree to passively (e.g., via a meter having a capability to identify content to which a panelist associated with the meter is exposed) and/or actively (e.g., via a survey to be completed by a panelist) submit information about actual exposures to advertisements and/or media carrying advertisements. Such information is typically extrapolated to provide exposure estimations for a broader population.

However, for some types of advertisement media, data provided by panelists is sometimes unavailable, insufficient or cost prohibitive for one or more purposes and/or for one or more entities interested in exposure information related to one or more advertisements. In such instances, additional or alternative techniques may be employed and/or additional or alternative types of exposure information may be collected. One such example is an out-of-home advertisement space. Locations or establishments at which out-of-home advertisements space(s) are posted are referred to herein as venues. The example methods, apparatus, systems, and/or articles of manufacture disclosed herein identify and/or categorize venues as residential-based venues or non-residential-based venues. Using the examples disclosed herein, residential-based venues can be identified as locations that are likely to be attended by people residing in or near a designated geographic area (i.e., local people). Example residential-based venues include convenient stores, coffee shops, shopping centers, groceries, gas stations, healthcare facilities, municipal buildings, etc. Using the examples disclosed herein, non-residential-based venues can be identified as locations that are likely to be attended by non-local people. Example non-residential venues include airports, resorts, hotels, theme parks, tourist attractions, amusement parks, etc. As described below, a venue can be treated as both a residential-based venue and a non-residential-based venue depending on, for example, an intended purpose of a user of the examples disclosed herein. For example, a user of the examples disclosed herein may wish to treat a gas station as residential-based venue for a first purpose (e.g., to reach local people) and as a non-residential-based venue for a second purpose (e.g., to reach people traveling that come across the gas station).

To gather exposure data associated with advertisements placed at an out-of-home space, some systems collect data related to a geographic area surrounding the out-of-home space. The data related to the geographic area can include, for example, demographic information associated with people residing in or near the geographic area (i.e., local people). The local demographic information can be used to estimate the likely composition of people exposed to advertisement(s) placed on the out-of-home space of a venue.

However, the examples disclosed herein recognize that while demographic information associated with a surrounding geographic area may be useful for residential-based venues, such information may be less useful or, in some cases, irrelevant for non-residential-based venues. The examples disclosed herein recognize that, with existing methods and systems related to evaluation of out-of-home advertisement spaces, the amount and quality of exposure information available for out-of-home spaces located at non-residential-based venues is limited. Accordingly, current methods of evaluating exposure to of out-of-home spaces located at non-residential-based venues are limited. Due to these limitations, media planners/strategists are often unable to quantify exposure to an out-of-home advertisement space located at a non-residential-based venue, advertisers often have difficulty committing to placement of advertisements at out-of-home spaces located at non-residential-based venues, owners of out-of-home spaces located at non-residential-based venues struggle to demonstrate exposure statistics related to the spaces to potential advertisers, and the lack of standardized or syndicated exposure data for out-of-home spaces located at non-residential-based venues often leads to uncertainty in decision making processes (e.g., whether, where and how to place advertisements of a campaign).

The example methods, apparatus, systems, and/or articles of manufacture disclosed herein recognize the need for exposure information related to out-of-home advertisement spaces located at non-residential-based venues. The example methods, apparatus, systems, and/or articles of manufacture provide an ability to generate such exposure information. As described in greater detail below, the examples disclosed herein identify types of people likely to attend certain non-residential-based venues. The examples disclosed herein use these identifications to generate venue profiles indicative of a likely composition of an audience exposed to out-of-home advertisement spaces located at certain types of non-residential-based venues. Moreover, the examples disclosed herein utilize the generated venue profiles to create one or more indexes that relate exposure data associated with the venue profiles with profiles associated with one or more advertisers. The profiles of the advertisers include information related to specific products and/or services and the people who are likely or less likely to purchase or consume those products and/or services. As a result, the example indexes disclosed herein are indicative of, for example, behavioral traits and/or consumption habits related to specific products and/or services of people likely to attend specific types of non-residential-based venues. Thus, generally, entities involved with targeted advertising campaigns can use the example venue profiles and/or the example indexes disclosed herein to evaluate one or more aspects of the out-of-home spaces located at the profiled non-residential-based venues. Additional and alternative aspects and benefits of the example methods, apparatus, systems, and/or articles of manufacture disclosed herein are described below and/or are apparent from the descriptions made herein and the corresponding drawings.

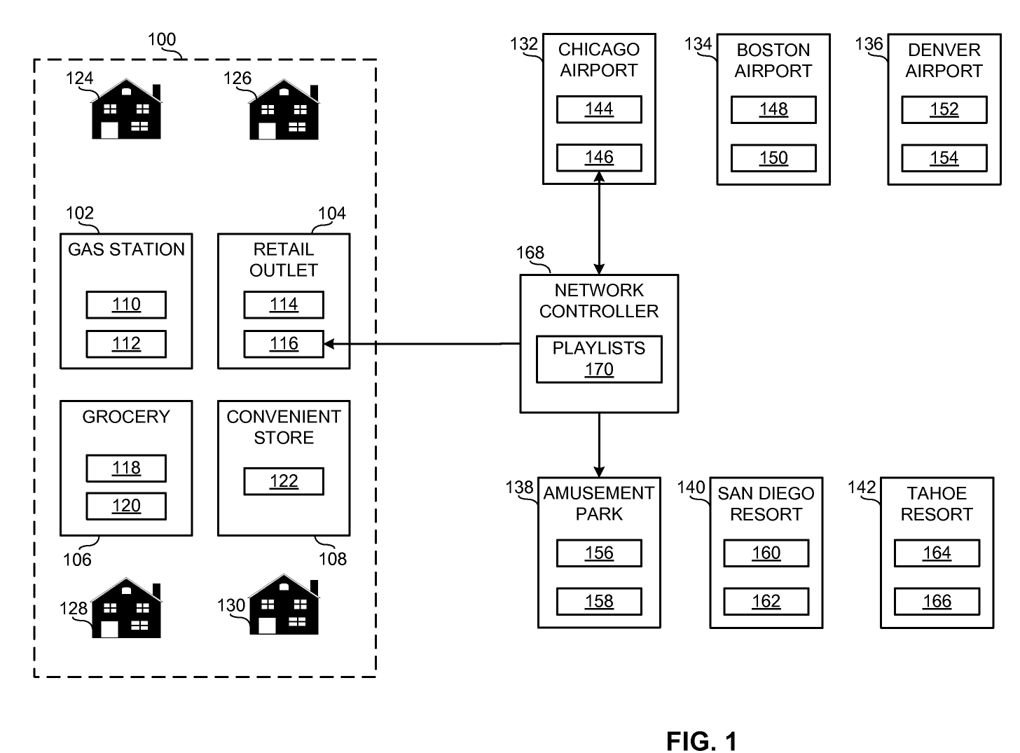

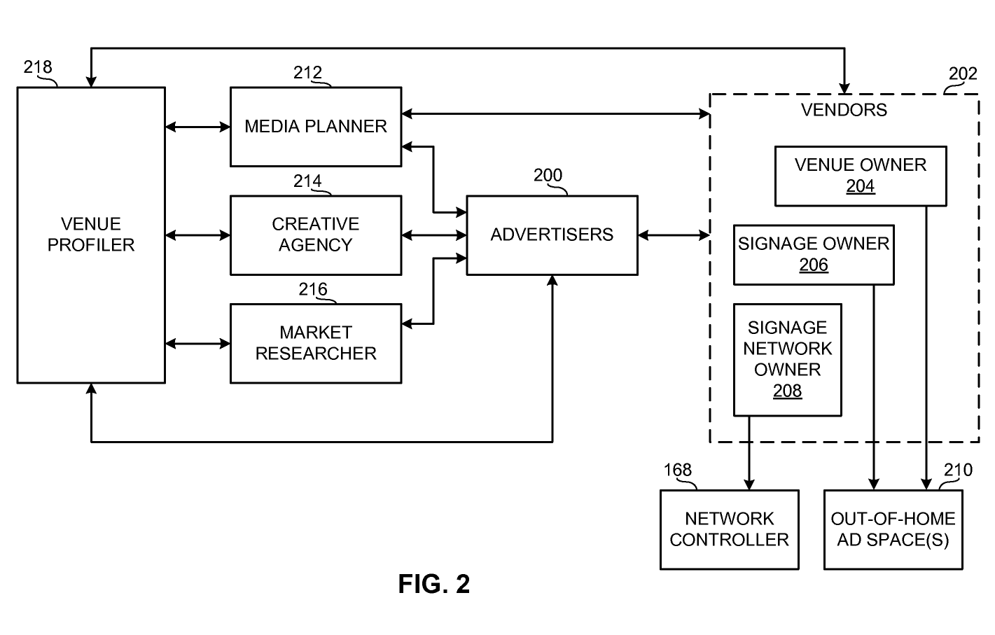

FIG. 1 is an illustration of a plurality out-of-home advertisement spaces located at a plurality of venues for which the example profiles and/or indexes disclosed herein can be generated. As described below in connection with FIG. 2, the examples disclosed herein identify a venue as residential-based or non-residential-based depending on, for example, how likely the attendees of the venue are people that reside in/near a geographic area including the venue and, conversely, how likely the attendees of the venue are people that reside outside the geographic area including venue. Such determinations can be based on studies, polls, extrapolations, raw data, etc. Example residential-based venues of a geographic area 100 are shown in FIG. 1 as a gas station 102, a retail outlet 104, a grocery store 106 and a convenient store 108. Each of the residential-based venues 102-108 includes at least one out-of-home advertisement space on which one or more advertisements can be placed. Example out-of-home advertisement spaces include digital or static signage posted inside or outside a venue, signage locations for printed advertisements, and/or any other suitable position capable of conveying an advertisement(s) to people attending the venues 102-108. Out-of-home spaces located at the example residential-based venues 102-108 of FIG. 1 are labeled with reference numerals 110-122. The example geographic area 100 of FIG. 1 also includes residences 124-130 of people likely to attend the residential-based venues 102-108. The example residences 124-130 of FIG. 1 include, for example, family homes, apartments, college dormitories, condominium buildings, etc.

Example non-residential-based venues are shown in FIG. 1 as a Chicago airport 132, a Boston airport 134 and a Denver airport 136, an amusement park 138, a San Diego resort 140 and a Lake Tahoe resort 142. Each of the non-residential-based venues 132-142 includes at least one out-of-home advertisement space on which one or more advertisements can be placed. Out-of-home spaces located at the example non-residential-based venues 102-108 of FIG. 1 are labeled with reference numerals 144-166. In the illustrated example, the non-residential-based venues 132-142 of FIG. 1 can include additional, alternative or similar types of out-of-home advertisement spaces as the residential-based venues 102-108. While the example venues of FIG. 1 are referred to above as either residential-based or non-residential-based, in some examples a venue may be characterized as a residential-based venue for some purposes and, at the same time, may be characterized as a non-residential-based venue for other purposes. In other words, the example disclosed herein can treat a venue as both a residential-based venue and non-residential-based venue depending on, for example, a target audience. For example, the Chicago airport may draw both local people and non-local people and, therefore, be treated as residential-based venue for some analyses and a non-residential-based venue for other analyses.

In the example of FIG. 1, some of the out-of-home spaces are owned and/or operated by different parties and/or entities. For example, an owner of a venue may own one or more of the out-of-home spaces located at that venue. With reference to FIG. 1, an owner of the retail outlet 104 owns a first out-of-home space 114 located in the retail outlet 104. At the same time, a third party (non-owner of the retail outlet 104) owns a second out-of-home space 116 located in the retail outlet 104. In some instances, such a third-party pays a fee to the venue owner (e.g., the retail outlet owner). That third party may also own a third out-of-home space 146 located at the Chicago airport 132 and all of the out-of-home spaces 156 and 158 located at the amusement park 138. That is, certain entities own out-of-home advertisement spaces across a plurality of venues. In such instances, the commonly owned out-of-home spaces may be collectively operated by a network controller 168. The network controller 168 controls, for example, which advertisements are displayed on the out-of-home spaces owned by an operator of the network controller 168. In the illustrated example, the network controller 168 includes a plurality of playlists 170, each including instructions related to advertisements, display durations, display times and/or other operational aspects to be implemented on the out-of-home spaces associated with the network controller 168. Some of the playlists 170 may correspond to digital signage that can serially and/or simultaneously display advertisements. Some of the playlists 170 may correspond to physically scrolling spaces that cycle through a set of printed advertisements. Some of the playlists 170 correspond to instructions to be conveyed to an entity charged with changing the content of printed billboard advertisements. For out-of-home spaces not operated by the network controller 168, instructions for the display of advertisement on each space can be received separately and/or for groups of the spaces (e.g., each of the out-of-home spaces 160 and 162 of the San Diego resort 140).

FIG. 2 is an illustration of a plurality of entities involved in decision making processes related to placement of advertisements at the out-of-home advertisement spaces 110-122 and 144-166 of FIG. 1. In particular, providers of goods and/or services wanting to advertise those goods and services typically employee and/or hire one or more of the entities shown in FIG. 2 to increase the benefits provided by advertising (e.g., establishment and maintenance of a brand, increased revenue, increased market share, image enhancement, etc.). In the illustrated example of FIG. 2, these providers of goods and/services are shown as advertisers 200. The example advertisers 200 of FIG. 2 may also include additional or alternative entities or parties interested in placing advertisements. To place advertisements at one or more of the out-of-home advertisement spaces 110-122 and 144-166 of FIG. 1, the advertisers enter into agreements with owners of the out-of-home advertisement spaces 110-122 and 144-166, which referred to in FIG. 2 as vendors 202. The example vendors 202 of FIG. 2 include a venue owner 204, a signage owner 206 and a signage network owner 208. With reference to FIG. 1, the example venue owner 204 owns the grocery 106, the example signage owner 206 owns a digital billboard 154 at the Denver airport 136, and the example signage network owner 208 operates the network controller 168 and owns the second space 116 located in the retail outlet 104, a space 146 located at the Chicago airport 132 and all of the out-of-home spaces 156 and 158 located at the amusement park 138. The example signage network owner 208 controls which advertisements and the manner in which the advertisements are placed at the spaces 116, 146, 156 and 158 owned thereby via the network controller 168. In the illustrated example, the spaces 106 and 154 owned by the venue owner 204 and the signage owner 206, respectively, which are shown in FIG. 2 with reference numeral 210, are controlled directly and/or with the assistance of a network controller similar to the network controller 168 of FIGS. 1 and 2.

Generally, agreements between the vendors 202 and the advertisers 200 call for the vendors 202 to display one or more advertisements provided by the advertisers 200 on one or more of the corresponding out-of-home advertisement spaces. Before selected one or more of the vendors 202 and/or one or more of the out-of-home advertisement spaces for placement of advertisement(s), the advertisers 200 usually develop an advertisement strategy that is embodied in a campaign. In many instances, the advertisers 200 hire one or more of a media planner 212, a creative agency 214, a market researcher 216, other entities or individuals having expertise in one or more area of the advertising industry. Services provided by one or more of the media planner 212, the creative agency 214 and the market researcher 216 may be offered by a single company or may span across different companies that work together on particular campaigns for particular ones of the advertisers 200.

Generally, the market researcher 216 studies market conditions, trends, historical data, etc. to develop reports and datasets indicative of aspects of different marketplaces. The creative agency 214 receives request from the advertisers 200 for advertisement content, such as television commercials, print advertisements for magazines, online advertisement content, and billboard advertisements for out-of-home spaces, for example. The media planner 212 works with the advertisers 200 to develop one or more advertisement campaigns that focus advertisement budgets on targeted advertisement media. To develop a campaign, the example media planner 212 of FIG. 2 uses data related to the out-of-home advertisement spaces 110-122 and 144-166 to evaluate the potential value to the advertisers 200 of placing one or more advertisements at the out-of-home advertisement spaces 110-122 and 144-166. Traditionally, the data used by the media planner 212 includes exposure information indicative of amounts and types of exposures to advertisement spaces, such as the out-of-home advertisement spaces 110-122 and 144-166 of FIG. 1.

The ability of the media planner 212 to evaluate the out-of-home advertisement spaces 110-122 and 144-166 relies on, for example, the accuracy, granularity, sample size and type of exposure information available for the out-of-home advertisement spaces 110-122 and 144-166. Vendors 202 (or representatives therefor) sometimes provide exposure information related to specific spaces to the media planner 212 (and directly to the advertisers 200) to attempt to persuade the media planner 212 to include the advertisement spaces of the respective vendor 202 in the campaign for particular products. Therefore, the ability of the vendors 202 to sell the out-of-home advertisement spaces 110-122 and 144-166 also relies on, for example, the accuracy, granularity, sample size and type of exposure information available for the out-of-home advertisement spaces 110-122 and 144-166 owned by the vendors 202. In other words, the media planner 212 is provided with significant and reliable exposure information related to, for example, a first one 110 of the out-of-home advertisement spaces 110-122 and 144-166, the media planner 212 can more easily identify the first out-of-home advertisement space 110 as a candidate for a particular campaign. Moreover, a lack of reliable or verifiable exposure information for an advertisement space or type of advertisement space often leads to uncertainty with regards to the evaluation of that advertisement space.

The examples disclosed herein recognize that better exposure information is needed for out-of-home advertisement spaces located at non-residential-based venues. To provide exposure information for out-of-home advertisement spaces located at non-residential-based venues, as well as behavioral data associated with the exposure information, the example of FIG. 2 includes a venue profiler 218. As shown in FIG. 2, the example venue profiler 218 is accessible to the media planner 212, the creative agency 214, the market researcher 216, the advertisers 200, and/or one or more of the vendors 202. The venue profiles 218 may be accessible to additional or alternative individuals or entities. In some instances, an entity that implements the venue profiler 218 may charge a fee for accessing and/or utilizing the example venue profiler 218 and/or the data generated thereby and/or stored thereon.

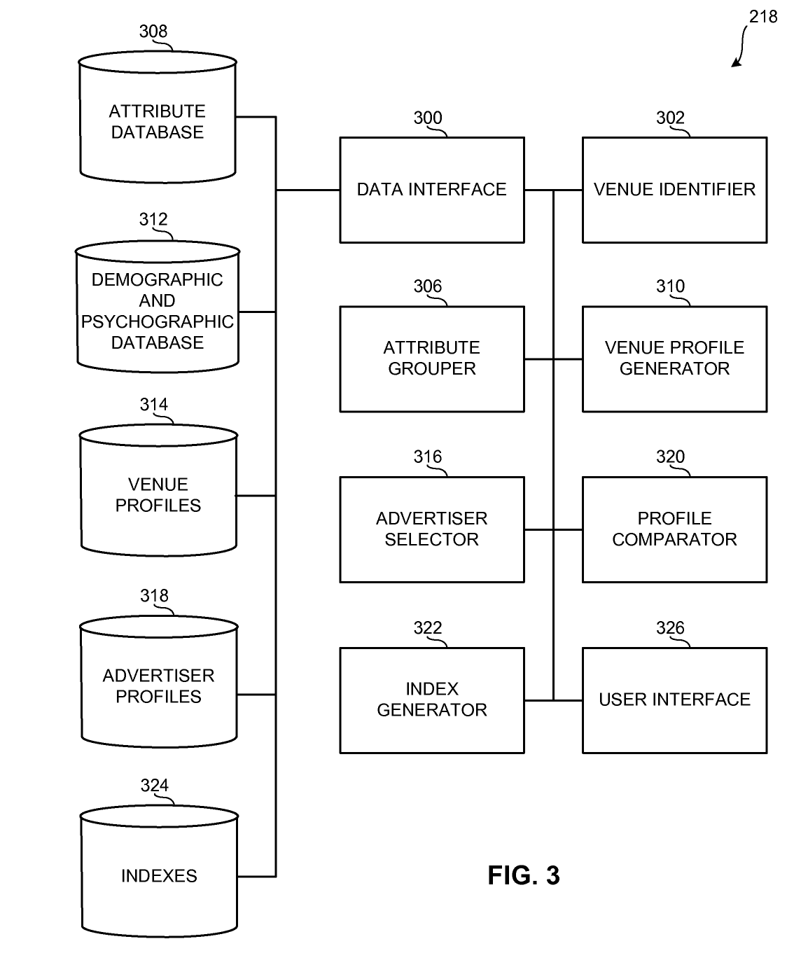

FIG. 3 illustrates an example apparatus that may be used to implement the example venue profiler 218 of FIG. 2. Generally, the example venue profiler 218 generates data usable (e.g., by the media planner 214 and/or the advertisers 200 of FIG. 2) to make decisions and/or recommendations regarding placement of advertisements at out-of-home spaces located at, for example, non-residential-based venues. In some examples, the venue profiler 218 can be applied to venues technically labeled as residential-based venues. The example venue profiler 218 of FIG. 3 includes a data interface 300, a venue identifier 302, an attribute grouper 306, an attribute database 308, a venue profile generator 310, a demographic and psychographic database 312, a collection of venue profiles 314, an advertiser selector 316, a collection of advertiser profiles 318, a profile comparator 320, an index generator 322, a collection of indexes 324, and a user interface 326. While an example manner of implementing the example venue profiler 218 of FIG. 2 is illustrated in FIG. 3, one or more of the elements, processes and/or devices illustrated in FIG. 3 may be combined, divided, re-arranged, omitted, eliminated and/or implemented in any other way. Further, the example data interface 300, the example venue identifier 302, the example attribute grouper 306, the example venue profiler generator 310, the example advertiser selector 316, the example profiler comparator 320, the example index generator 322, the example user interface 326, and/or, more generally, the example venue profiler 218 of FIG. 3 may be implemented by hardware, software, firmware and/or any combination of hardware, software and/or firmware. Thus, for example, any of the example data interface 300, the example venue identifier 302, the example attribute grouper 306, the example venue profiler generator 310, the example advertiser selector 316, the example profiler comparator 320, the example index generator 322, the example user interface 326, and/or, more generally, the example venue profiler 218 of FIG. 3 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the example data interface 300, the example venue identifier 302, the example attribute grouper 306, the example venue profiler generator 310, the example advertiser selector 316, the example profiler comparator 320, the example index generator 322, the example user interface 326, and/or, more generally, the example venue profiler 218 of FIG. 3, are hereby expressly defined to include a computer readable medium such as a memory, DVD, CD, etc. storing the software and/or firmware. Further still, the example venue profiler 218 of FIG. 3 may include one or more elements, processes and/or devices in addition to, or instead of, those illustrated in FIG. 3, and/or may include more than one of any or all of the illustrated elements, processes and devices.

The example data interface 300 enables communication between, for example, the collections and databases 308, 312, 314, 318, and 324 and the other components 302, 306, 310, 316, 320, 322 and 326 of the example venue profiler 218. While the example venue profiler 218 is shown in FIG. 3 as including the attribute database 308, the demographic and psychographic database 312, the collection of venue profiles 314, the collection of advertiser profiles 318, and the collection of indexes 314, one or more of the attribute database 308, the demographic and psychographic database 312, the collection of venue profiles 314, the collection of advertiser profiles 318, and the collection of indexes 314 may be in communication with the example venue profiler 218 and accessible thereby at a location separate from the example venue profiler 218. In such instances, the example data interface 300 enables the venue profiler 218 and/or the components thereof to communicate across different protocols, formats, standards, networks, etc. Any of the example exchanges of information, requests, responses, queries, etc. described herein between the components of the venue profiler 218 shown in FIG. 3 may be facilitated, at least in part, by the example data interface 300. In some examples, one or more of the components of the venue profiler 218 communicate directly or without the data interface 300.

The example venue identifier 302 designates respective venues as either a residential-based venue or a non-residential-based venue depending on, for example, a first likelihood that attendees of a venue will be local people a second likelihood that the attendees of the venue are non-local people. In the illustrated example, the venue identifier 302 designates a venue as a residential-based venue when the first likelihood is greater than the second likelihood, and the venue identifier 302 designates the venue as non-residential-based when the second likelihood is greater than or equal to the first likelihood. In some examples, the venue identifier 302 can use alternative algorithm(s) to designate a venue as either a residential-based venue or a non-residential-based venue. For example, for the venue identifier 302 to designate a venue as non-residentially-based, the second likelihood may have to be a certain percentage greater than the first likelihood. Further, the example venue identifier 302 may indicate that some venues are both residentially-based and non-residentially-based. In such instances, a first profile based on the surrounding geographic area can be generated for the venue in the context of a residential-based-venue and a second profile based on people likely to attend the venue can be generated for the venue in the context of a non-residential-based venue.

With reference to FIG. 1, the example venue identifier 302 determines that the gas station 102, the retailer 104, the grocery store 106 and the convenient store 108 are likely to draw mostly people residing at the residences 124-130 of the geographic area 100. Accordingly, the example venue identifier 302 designates the gas station 102, the retailer 104, the grocery 106 and the convenient store 108 as residential-based venues. Again with reference to FIG. 1, the example venue identifier 302 determines that the airports 132-136, the amusement park 138 and the resorts 140 and 142 are likely to draw mostly non-local people. Accordingly, the example venue identifier 302 designates the airports 132-136, the amusement park 138 and the resorts 140 and 142 as non-residential-based venues. The example venue identifier 302 bases these determinations on estimations provided by experts, studies, raw data, and/or any other suitable source of information. The example venue identifier 302 can make the designations based on inputs received from a person, an automated system, or some combination of inputs from the person and the automated system.

In the illustrated example, the venue identifier 302 designates venue types that fall under a non-residential-based category. For example, the venue identifier 302 may designate airports as non-residential-based and shopping centers as residential-based. Additionally, in some examples, the venue identifier 302 may create more categories under which certain venues may fall. For example, the venue identifier 302 may designate international airports as non-residential-based venues, but smaller, local airports as residential-based venues. As another example, the venue identifier 302 may designate a home field of a local sports team, such as a minor league baseball team, as a residential-based venue, but a sports arena of a professional team, such as a Major League® baseball team, as a non-residential-based venue. As another example, the venue identifier 302 may designate the Chicago airport 132 as a hybrid venue due to the likely attendance of both local people and non-local people. Thus, the example venue identifier 302 can make any suitable number of distinctions among types of venues.

The example attribute grouper 306 utilizes the example attribute database 308 to develop a group of attributes for each type of venue designated by the example venue identifier 302. The example attribute database 308 of FIG. 3 includes one or more lists of attributes assigned to people by, for example, a creator of syndicated market research data (e.g., the market researcher 216 of FIG. 2). Example attributes include “travels domestically on business by airplane three or more times per year,” “travels domestically on personal trips by airplane three or more times per year,” “travels internationally one or more times per year,” “stays at an all-inclusive resort one or more times per year,” and “stays at a Radisson® hotel one time per year.” Many other attributes associated with behavior and consumption of people are available and can be utilized by the examples disclosed herein. For desired venue type (e.g., airport, resort, amusement park, etc.) designated by the example venue identifier 302, the example attribute grouper 304 selects a group of the attributes stored in the attribute database 308. The example attribute grouper 304 may select attributes from additional or alternative sources. The example attribute grouper 304 selects attributes for each venue that correspond to a behavior that indicates that the associated person attends the venue. For example, the example attribute grouper 304 of the illustrated example selects the attribute “travels domestically on business three or more times per year” for the airports 132-136 of FIG. 1. Also, the example attribute grouper 304 of FIG. 3 selects the attribute “visits any Six Flags® one or more times per year” for the amusement park 138 of FIG. 1 and other amusement parks. Table I shows an example grouping of attributes as selected by the example attribute grouper 304 for an example set of non-residential-based venues (e.g., as designated by the example venue identifier 302).

TABLE I

| VENUE | SELECTED ATTRIBUTES |
|---|---|
| Airports (all venues) | Domestic Business Travel by Airplane, 3+, 1 yr |
| | Domestic Personal Travel by Airplane, 3+, 1 yr |
| | Foreign Travel, 2+ Trips, 3 yr |
| | Member of Any Frequent Flyer Programs |
| | Member of Continental Frequent Flyer Program |
| | Member of Delta Frequent Flyer Program |
| | Member of United Airlines Frequent Flyer Program |
| | Member of USAir Frequent Flyer Program |
| Convenient Stores at | Domestic Business Travel by Airplane, 3+, 1 yr (A) |
| Airports | Foreign Travel, 2+ Trips, 3 yr (A) |
| Entertainment - | Visit Gambling Casinos, 1 year |
| Casino & Gambling | Go to Gambling Casinos, 1 year |
| | Gamble at Atlantic City, 1 year |
| | Gamble at Las Vegas, 1 year |
| | Gamble at Lake Tahoe/Reno, 1 year |
| | Gamble on River Boat, 1 year |
| | Gamble at Caribbean Island, 1 year |
| | Gamble at Indian Reservation, 1 year |
| | Gamble on Cruise Ship, 1 year |
| Entertainment - | Sporting Event |
| Racetrack | Fan of Auto Racing |
| | Fan of Boxing |
| | Fan of College Basketball |
| | Fan of College Football |
| | Fan of Ice Hockey |
| | Fan of Indy Car Racing |
| | Fan of NASCAR Racing |
| | Fan of NBA Professional Basketball |
| | Fan of Professional Baseball |
| | Fan of Professional Football |
| | Fan of Rodeo ( |
| | Fan of Truck Racing/Pulls |
| | Fan of WNBA Professional Basketball |
| | Go to Rock/Pop Concert, 1 yr |
| | Buy Rap/Hip Hop Music, 1 y |
| | Buy Alternative/Hard rock music, 1 yr |
| | Buy Country Music, 1 yr |
| | Buy Contemporary Pop Music, 1 yr |
| | Music is an important part of my life |
| | Go to Music/Dance performance, 1 yr |
| Hospitality - Hotel | Stay at All-Inclusive Resort, 1 yr (A) |
| | Stay at Domestic Hotel/Motel, 1 yr (A) |
| | Stay at Public/Private Campground, 1 yr (A) |
| | Stay Best Western on Vacation, 1 yr (A) |
| | Stay Comfort Inn on Vacation, 1 yr (A) |
| | Stay Days Inn on Vacation, 1 yr (A) |
| | Stay Hilton on Vacation, 1 yr (A) |
| | Stay Holiday Inn on Vacation, 1 yr (A) |
| | Stay Hyatt on Vacation, 1 yr (A) |
| | Stay Marriott on Vacation, 1 yr (A) |
| | Stay Motel 6 on Vacation, 1 yr (A) |
| | Stay Radisson on Vacation, 1 yr (A) |
| | Stay Ramada Inn on Vacation, 1 yr (A) |
| | Stay Red Roof Inn on Vacation, 1 yr (A) |
| | Domestic Travel, Hotel Stay 1-5 nights, 1 yr (A) |
| | Domestic Travel, Hotel Stay 6+ nights, 1 yr (A) |
| Hospitality - Resort | Stay at All-Inclusive Resort, 1 yr |
| | Stay at Domestic Hotel/Motel, 1 yr |
| | Stay at Public/Private Campground, 1 yr |
| | Stay Best Western on Vacation, 1 yr |
| | Stay Comfort Inn on Vacation, 1 yr |
| | Stay Days Inn on Vacation, 1 yr |
| | Stay Hilton on Vacation, 1 yr |
| Hospitality - | Visit any Busch Gardens 1 y |
| Tourism | Visit any Disney Theme park 1 yr |
| & Attractions | Visit any Seaworld, 1 yr |
| | Visit any Six Flags, 1 y |
| | Visit any Theme Park, 1 yr |
| | Visit any Universal Studios, 1 yr |

Thus, the example venue identifier 302 and the example attribute grouper 304 provide a plurality of venue types designated as non-residential-based venues and, for each of the plurality of venue types, at least one attribute associated with people likely to attend the respective type of venue. In the illustrated example, the venue profile generator 310 interacts with the demographic and psychographic database 312 to generate a venue profile for each of the identified venue types. In particular, the example venue profile generator 310 queries the demographic and psychographic database 312 to obtain demographic and/or psychographic data associated with each attribute grouped into the respective venue type by the example attribute grouper 306. For example, when generating a profile for airports, the example venue profile generator 310 sends the attribute “travels domestically for business three or more times per year” to the demographic and psychographic database 312 and requests demographic and/or psychographic data associated with people having that attribute. The example demographic and psychographic database 312 responds with statistics associated with the received attribute. The example venue profile generator 310 receives the demographic and/or psychographic data and adds the same to a venue profile for the venue profile being generated. The example venue profile generator 310 of FIG. 3 obtains such data for the attributes grouped together by the attribute grouper 306 for each venue type and combines the received demographic and/or psychographic data to form a venue profile for each venue type. In the illustrated example, the resulting profiles are stored in the collection of venue profiles 314. Moreover, the example venue profiles 314 generated by the example venue profile generator 310 can be generated for venues otherwise labeled as residential-based venues (e.g., by the venue identifier 302). In other words, the venue profiles 314 generated using the example disclosed herein can be generated for any type of venue as a standalone profile or as a combination of the type of venue profile generated by the example venue profile generator 310 and a geographic profile generated based on a geographic area surrounding a residential-based venue or a non-residential-based venue.

The example venue profiler 218 of FIG. 3 also enables a specific advertiser to compare aspects of the advertiser and/or products/services provided by the advertiser to the venue profiles 314. In the illustrated example, the aspects of the advertiser and/or products/services provided by the advertiser are stored in the collection of advertiser profiles 318. For example, the aspects of the advertiser may include one or more target demographics and one or more target psychographics of the advertiser for a specific campaign and/or for the advertiser in general. For example, when a first one of the advertiser profiles 318 corresponds to a car company, the content of the first advertiser profile may indicate that the car company wishes to target males, age 25-32 for a sports car manufactured by the car company and that the car company wishes to target males, age 45-60 for a luxury car manufactured by the car company. Additionally or alternatively, the advertiser profiles 318 may include a categorization for products/services provided by the advertiser, brand names corresponding to the products/services provided by the advertiser, etc.

With reference to FIG. 2, when one of the advertisers 200 or the media planner 212 wishes to utilize the example venue profiler 218 to compare aspects of one of the advertisers 200 and/or a specific product/service offered thereby, the example advertiser selector 316 receives an indication of the chosen advertiser and/or product/service offered thereby. The example advertiser selector 316 then obtains the corresponding one of the advertiser profiles 318 and conveys the same to the example profile comparator 320. The example profile comparator 320 also receives one or more of the venue profiles 314 for comparison against the selected advertiser profile 318. To continue the above example, the media planner 212, in working for the car company, may wish to evaluate the airports 132-136 as candidates for placement of a sports car advertisement at digital billboards located in the airports 132-136. In such instances, the media planner 212 may instruct the example venue profiler 218 to compare an advertiser profile corresponding to the car company and/or the sports car to a venue profile for airports. In response, the example profile comparator 320 compares the selected one of the advertiser profiles 318 to the selected one of the venue profiles 314. As described above, the selected one of the venue profiles 314 includes demographic and/or psychographic data related to people likely to attend the airports 132-136. Further, the selected one of the advertiser profiles 318 includes target demographic and/or psychographic data related to target audiences of the car company. The example profile comparator 320 of FIG. 3 determines a degree of matching between the selected advertiser profile and the selected venue profile.

In some examples, the media planner 212 (or any other user of the example venue profiler 218) may request a comparison of a profile of an advertiser to a plurality (or all) of the venue profiles 314. In such instances, the example profile comparator 320 of FIG. 3 determines a degree of matching between the selected advertiser profile and each of the requested venue profiles 314. In some examples, the degree of matching represents a sum of a plurality of matching degrees, each corresponding to a segment defined by a segmentation system (e.g., PRIZM) That is, the degree of matching can be determined by a sum of individual comparisons made between the venue profile and the advertiser profile at each segmentation level of a segmentation system. The results of the individual comparisons are also make available as part of the generated results. In some instances, the results of the comparisons can be grouped together as related comparison results.

The results of the comparison(s) performed by the example profile comparator 320 are conveyed to the example index generator 322. In the illustrated example, the index generator 322 assigns a score or index to the comparison requested by the media planner 212. Generally, the score or index generated by the example index generator 322 represents a concentration of targeted demographics and/or psychographics for the corresponding advertiser associated with the compared advertiser profile at the venue type associated with the compared venue profile(s). In some examples, the index generated by the index generator 322 is a ratio of the degree of matching calculated by the profile comparator 320 to a degree of matching of an overall population (e.g., the population of the United States). In other words, the example index generator 322 can generate an index indicative of how well the advertiser profile matches the venue profile versus how well the advertiser profile matches an overall population. The example index generator 322 can generate such an index according to the following equation:

$$Equation 1 \text{:} \frac{MatchCountOfComparator}{MatchCountOfPopulation} \times 100 = Index$$

In such instances, the MatchCountOfComparator corresponds to the degree of matching calculated by the example profile comparator 320 and the MatchCounterOfPopulation corresponds to a degree of matching for a larger population determined by, for example, surveys and/or other collection techniques.

The index generator 322 may process the data received from the example profile comparator 320 and/or directly from any other component(s) of the example venue profiler 218 to generate additional or alternative statistics related to the example venue profiles 314. For example, when a comparison is requested between an advertiser profile and a plurality of venue profiles, the example index generator 322 may score and then rank the results. The resulting indexes and/or any other statistics are stored in the index database 324.

In some instances, the venue profiler 218 receives a request to compare an advertiser profile 318 with a plurality of the venue profiles 314. In such examples, the index generator 322 creates a ranking of the resulting indexes and stores the same in the index database 324. The rankings may be sortable and/or otherwise able to be manipulated or explored by a user of the user interface 326. The example user interface 326 enables any suitable request to be communicated to the example venue profiler 218 and any suitable communication of the resulting data to the requesting user.

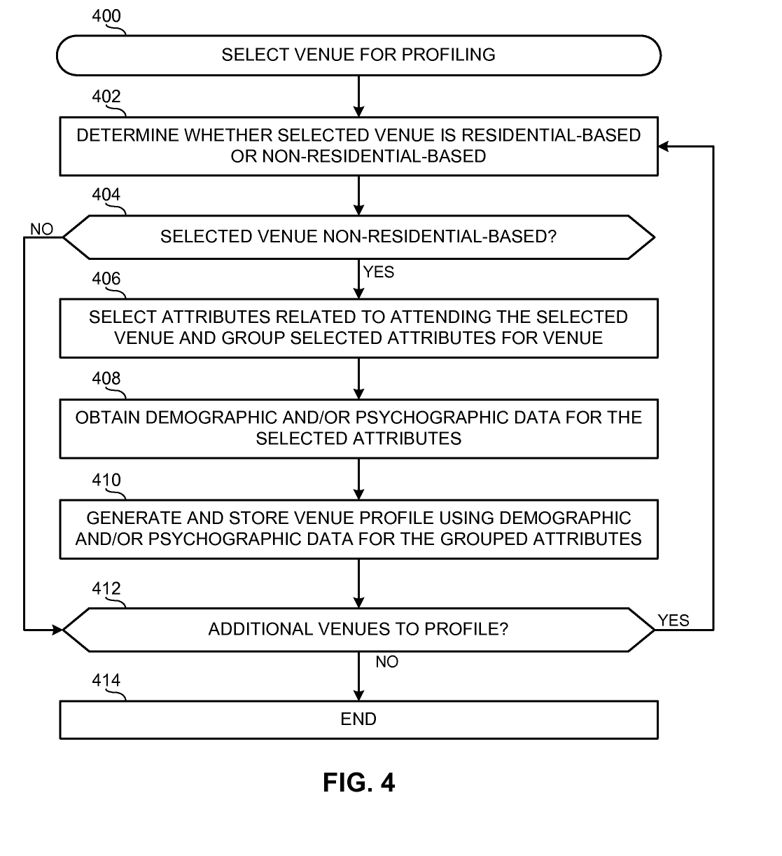

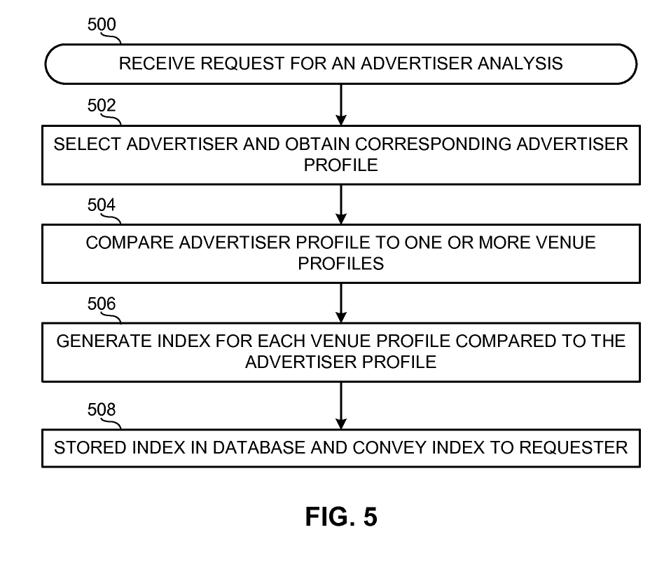

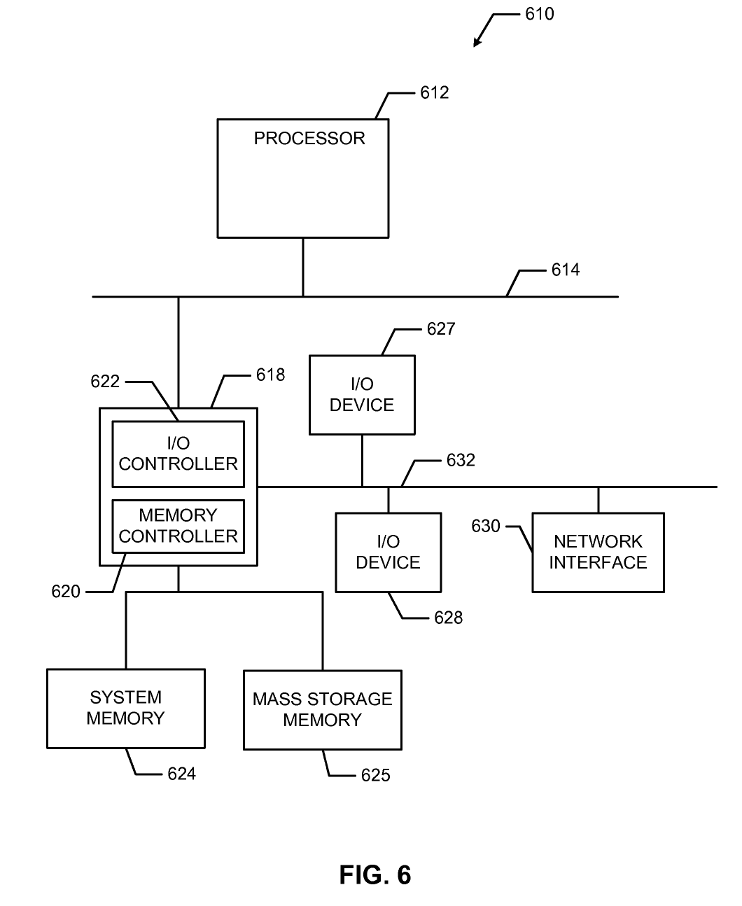

FIGS. 4 and 5 are flowcharts representative of example machine readable instructions that may be executed to implement the example venue profiler 218 of FIGS. 2 and/or 3. In the examples of FIGS. 4 and 5, the machine readable instructions comprise a program for execution by a processor such as the processor 612 shown in the example computer 600 discussed below in connection with FIG. 6. The program may be embodied in software stored on a computer readable medium such as a CD-ROM, a floppy disk, a hard drive, a digital versatile disk (DVD), or a memory associated with the processor 612, but the entire program and/or parts thereof could alternatively be executed by a device other than the processor 612 and/or embodied in firmware or dedicated hardware. Further, although the example programs are described with reference to the flowcharts illustrated in FIGS. 4 and 5, many other methods of implementing the example venue profiler 218 of FIGS. 2 and/or 3 may alternatively be used. For example, the order of execution of the blocks may be changed, and/or some of the blocks described may be changed, eliminated, or combined.

As mentioned above, the example processes of FIGS. 4 and 5 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 4 and 5 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Generally, the program of FIG. 4 generates profiles for non-residential-based venues. The program of FIG. 4 begins at block 400 when a first venue is selected for profiling. For purposes of illustration, the venue selected at block 400 in the example of FIG. 4 is an airport. That is, the example program 400 of FIG. 4 corresponds to an instance of the venue profiler 218 of FIGS. 2 and/or 3 profiling airports having out-of-home advertisement space(s) available for advertising. The example venue identifier 302 (FIG. 3) determines whether airports are non-residential-based venues or residential-based venues (block 402). When the example venue identifier 302 determines that the selected venue is a residential-based venue (block 404), control proceeds to block 412. Otherwise, the example attribute grouper 306 (FIG. 3) selects attributes from the attribute database 308 (FIG. 3) that are related to a corresponding person attending the selected venue and groups the selected attributes together for the selected venue (block 406). For example, for the selected venue of airports in the illustrated example, the attribute grouper 306 selects attributes entitled ‘travels domestically three or more times per year’ and ‘member of frequent flyer program’ and groups those attributes together for a venue profile for airports.

The example venue profile generator 310 (FIG. 3) then obtains demographic and/or psychographic data from the demographic and psychographic database 312 (FIG. 3) that corresponds to the attributes selected by the attribute grouper 306 (block 408). In the illustrated example, the venue profile generator 310 queries the demographic and psychographic database 312 using the attributes and receives demographic and psychographic information in return. The example venue profile generator 310 then generates and stores a venue profile for the selected venue type (e.g., airports) using the received demographic and/or psychographic data (block 410). The generation of the venue profile may include combining the selected attributes and the corresponding demographic and/or psychographic data into a file and/or report with any suitable post-processing summarization included therein. When additional venues remain unprofiled (block 412), control returns to block 402. Otherwise the example of FIG. 4 ends (block 414).

Generally, FIG. 5 enables a comparison between aspects of an advertiser and the venue profiles generated via the example processes of FIG. 4. In particular, the example venue profiler 218 of FIGS. 2 and/or 3 receives a request for an analysis of one or more venue types as potential advertisement locations for a particular advertiser (block 500). In response to the request, the example advertiser selector 316 (FIG. 3) determines an identity of the advertiser that is the subject of the request and obtains a corresponding advertiser profile from the collection of advertiser profiles 318 (FIG. 3) (block 502). The example profile comparator 320 then compares the advertiser profile to one or more of the venue profiles 314 (block 504) to determine a degree of matching between the profiles. The example index generator 322 (FIG. 3) then generates an index or score for each of the venue profiles 314 compared to the selected one of the advertiser profiles 318 (block 506) and stores the same in the index database 324 (FIG. 3) (block 508).

FIG. 6 is a block diagram of an example computer 600 capable of executing the instructions of FIGS. 4 and/or 5 to implement the example venue profiler 218 of FIGS. 2 and/or 3. The computer 600 can be, for example, a server, a personal computer, a mobile phone (e.g., a cell phone), a personal digital assistant (PDA), an Internet appliance, a set top box, or any other type of computing device.

The computer 600 of the instant example includes a processor 612. For example, the processor 612 can be implemented by one or more Intel® microprocessors from the Pentium® family, the Itanium® family or the XScale® family. Of course, other processors from other families are also appropriate.

The processor 612 is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is typically controlled by a memory controller (not shown).

The computer 600 also includes an interface circuit 620. The interface circuit 620 may be implemented by any type of interface standard, such as an Ethernet interface, a universal serial bus (USB), and/or a PCI express interface.

One or more input devices 622 are connected to the interface circuit 620. The input device(s) 622 permit a user to enter data and commands into the processor 612. The input device(s) can be implemented by, for example, a keyboard, a mouse, a touchscreen, a track-pad, a trackball, isopoint and/or a voice recognition system.

One or more output devices 624 are also connected to the interface circuit 620. The output devices 624 can be implemented, for example, by display devices (e.g., a liquid crystal display, a cathode ray tube display (CRT), a printer and/or speakers). The interface circuit 620, thus, typically includes a graphics driver card.

The interface circuit 620 also includes a communication device (e.g., the request servicer) such as a modem or network interface card to facilitate exchange of data with external computers via a network 626 (e.g., an Ethernet connection, a digital subscriber line (DSL), a telephone line, coaxial cable, a cellular telephone system, etc.).

The computer 600 also includes one or more mass storage devices 628 for storing software and data. Examples of such mass storage devices 628 include floppy disk drives, hard drive disks, compact disk drives, and digital versatile disk (DVD) drives. The mass storage device 628 may implement the storage database 160.

The coded instructions of FIG. 4 may be stored in the mass storage device 628, in the volatile memory 614, in the non-volatile memory 616, and/or on a removable storage medium such as a CD or DVD.

From the foregoing, it will appreciate that the above disclosed methods, apparatus and articles of manufacture provide panelists with different types of information related to data related to purchases made by the panelists and/or members of households to which the panelists belong. The panelists can use the information conveyed via the disclosed methods, apparatus, and articles of manufacture described herein to become better informed on, for example, the shopping habits, potential savings, consumption trends, and/or health and wellness of the household 108. This can lead to better purchasing decisions from, for example, a financial standpoint and from a health standpoint. That is, the example methods, apparatus and articles of manufacture described herein enable panelists to evaluate, track, and improve the efficient utilization of a budget and the eating habits of the household 108, for example. Furthermore, the example methods, apparatus and articles of manufacture described herein inform panelists on how the behavior and/or habits of the household 108 compare with other groups of people, such as neighbors or demographically similar people. Panelist can utilize such information to set a goal for improving, for example, overall health and wellness of the household 108 by altering the foods purchased for the household 108. Additional and alternative benefits and uses of the example methods, apparatus and articles of manufacture described herein will be readily apparent from the drawings and the above description.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed:

1. A method, comprising:
selecting an attribute for a non-residential-based venue indicative of a type of person likely to attend the non-residential-based venue;
obtaining at least one of demographic data or psychographic data associated with the attribute; and
generating, using a processor, a venue profile for the non-residential-based venue using the at least one of the demographic data or psychographic data associated with the attribute.

2. A method as defined in claim 1, further comprising generating an index for the non-residential-based venue for an advertiser using a comparison of an advertiser profile associated with the advertiser and the venue profile.

3. A method as defined in claim 2, wherein the comparison of the advertiser profile and the venue profile produces a first degree of matching between a first aspect of the advertiser profile and a first aspect of the venue profile.

4. A method as defined in claim 3, wherein the index comprises a ratio of the first degree of matching to a second degree of matching of an overall population.

5. A method as defined in claim 3, wherein the degree of matching represents a sum of a plurality of matching degrees, each of the matching degrees corresponding to a segment defined by a segmentation system.

6. A method as defined in claim 2, wherein generating the index comprises obtaining the advertiser profile in response to receiving a request associated with the advertiser.

7. A method as defined in claim 2, further comprising conveying the index to an entity associated with the request.

8. A method as defined in claim 1, wherein the venue is identified as a non-residential-based-venue based on a likelihood that attendees of the venue reside outside of a geographic area including the venue.

9. A tangible machine readable medium having instructions stored thereon that, when executed, cause a machine to at least:
select an attribute for a non-residential-based venue indicative of a type of person likely to attend the non-residential-based venue;
obtain at least one of demographic data or psychographic data associated with the attribute; and
generate a venue profile for the non-residential-based venue using the at least one of the demographic data or psychographic data associated with the attribute.

10. A machine readable medium as defined in claim 9, the instruction to cause the machine to generate an index for the non-residential-based venue for an advertiser using a comparison of an advertiser profile associated with the advertiser and the venue profile.

11. A machine readable medium as defined in claim 10, wherein the comparison of the advertiser profile and the venue profile produces a first degree of matching between a first aspect of the advertiser profile and a first aspect of the venue profile.

12. A machine readable medium as defined in claim 11, wherein the index comprises a ratio of the first degree of matching to a second degree of matching of an overall population.

13. A machine readable medium as defined in claim 11, wherein the degree of matching represents a sum of a plurality of matching degrees, each of the matching degrees corresponding to a segment defined by a segmentation system.

14. A machine readable medium as defined in claim 10, wherein generating the index comprises obtaining the advertiser profile in response to receiving a request associated with the advertiser.

15. A machine readable medium as defined in claim 10, the instructions to cause the machine to convey the index to an entity associated with the request.

16. A machine readable medium as defined in claim 9, wherein the venue is identified as a non-residential-based-venue based on a likelihood that attendees of the venue reside outside of a geographic area including the venue.

17. An apparatus, comprising:
a selector to select an attribute for a non-residential-based venue indicative of a type of person likely to attend the non-residential-based venue;
a retriever to obtain at least one of demographic data or psychographic data associated with the attribute; and
a profile generator to generate a venue profile for the non-residential-based venue using the at least one of the demographic data or psychographic data associated with the attribute.

18. An apparatus as defined in claim 17, further comprising an index generator to generate an index for the non-residential-based venue for an advertiser using a comparison of an advertiser profile associated with the advertiser and the venue profile.

19. An apparatus as defined in claim 18, wherein the comparison of the advertiser profile and the venue profile produces a first degree of matching between a first aspect of the advertiser profile and a first aspect of the venue profile.

20. An apparatus as defined in claim 19, wherein the index comprises a ratio of the first degree of matching to a second degree of matching of an overall population.

21. An apparatus as defined in claim 19, wherein the degree of matching represents a sum of a plurality of matching degrees, each of the matching degrees corresponding to a segment defined by a segmentation system.

22. An apparatus as defined in claim 18, wherein generating the index comprises obtaining the advertiser profile in response to receiving a request associated with the advertiser.

23. An apparatus as defined in claim 18, further comprising an interface to convey the index to an entity associated with the request.

24. An apparatus as defined in claim 17, further comprising a venue identifier to identify the venue as a non-residential-based-venue based on a likelihood that attendees of the venue reside outside of a geographic area including the venue.
